(19) United States
(12) Patent Application Publication
(10) Pub. No.: US 2012/0143431 A1
(43) Pub. Date: Jun. 7, 2012

(54) DIAGNOSTIC APPARATUS USING A MICROPHONE

(75) Inventors: Sang Ki Kim, Uiwang (KR); Suk Young Rho, Anyang (KR); Don Hyoung Lee, Anyang (KR); Jeong Hwan Hwang, Suwon (KR); Jeong Yeol Kim, Suwon (KR); Seong Il Kim, Seoul (KR)

(73) Assignees: HYUNDAI MOTOR COMPANY, Seoul (KR); C&S TECHNOLOGY CO., LTD., Seoul (KR); KIA MOTORS CORPORATION, Seoul (KR)

(21) Appl. No.: 13/173,461

(22) Filed: Jun. 30, 2011

(30) Foreign Application Priority Data
Dec. 6, 2010 (KR) 10-2010-0123821

(51) Int. Cl. G06F 7/00

(52) U.S. Cl. 701/29.1; 701/32.8

(57) ABSTRACT

The present invention provides a diagnostic apparatus using a microphone. More specifically, the diagnostic apparatus utilizes a first microphone, a second microphone, a first unit, a controller and second unit. The first microphone is positioned within an engine compartment and the second microphone is positioned within an interior of a vehicle to receive the noise. The second unit records the noise inputted through the first microphone or the second microphone or both and the controller analyzes and diagnoses a vehicle utilizing the noise recorded by the first unit to determine if a failure in the vehicle has occurred. When a vehicle failure is detected by the controller, the second unit then notifies a user of the location of a failed part in the vehicle.

### CROSS-REFERENCES TO RELATED APPLICATIONS

Priority to Korean Patent Application Number 2010-0123821, filed on Dec. 6, 2010, which is incorporated herein by reference in its entirety, is claimed.

### BACKGROUND OF THE INVENTION

1. Field of the Invention

The present invention relates to a diagnostic apparatus using a microphone, and more particularly, to a diagnostic apparatus that can diagnose a failure within a vehicle by using a microphone provided within an engine compartment and a vehicle's interior.

2. Description of the Related Art

When a vehicle breaks down, a noise is typically generated by a vehicle while an engine is running within the vehicle. Sometimes, when the noise is intermittent and not continuous, or is generated only when the vehicle is driven at a high speed, it is difficult for a user to precisely describe the noise to a service technician so that a proper repair or replacement of parts may not performed. Therefore, there is a need for an apparatus that can store noises from within the vehicle so that the sound can be reproduced as desired.

Also, it is difficult for the user to identify whether the noise in the vehicle is due to a simple wear and tear or a mechanical breakdown that needs to be repaired, and therefore, specified and prompt vehicle maintenance is not ensured. Thus, there is a need for an apparatus that can determine that a vehicle is breaking down based on the noise generated in the vehicle and accordingly inform the user about information regarding the vehicle's state.

### SUMMARY OF THE INVENTION

The present invention provides a diagnostic apparatus that can record a noise detected in an engine compartment and/or a vehicle's interior, analyze the recorded noise to diagnose a vehicle breakdown, and detect a location of a failed part related to the noise.

In accordance with an aspect of the present invention, a diagnostic apparatus comprises: a first microphone positioned within an engine compartment to receive a noise; a second microphone positioned within an interior of a vehicle to receive the noise; a recordation unit configured to record the noise inputted through the first microphone or the second microphone; a controller configured to diagnose a vehicle breakdown by analyzing the noise recorded by the recordation unit; and a user notification unit configured to, when a vehicle breakdown is detected by the controller, notify the user of a location of a failed part.

In accordance with another aspect of the present invention, a diagnostic apparatus that communicates with a telematics server comprises: a first microphone positioned within an engine compartment to receive a noise; a second microphone positioned within an interior of a vehicle to receive the noise; a recordation unit configured to record the noise inputted through the first microphone or the second microphone; and a wireless transmission unit configured to transmit the noise recorded by the recordation unit to the telematics server in a remote location.

### BRIEF DESCRIPTION OF THE DRAWINGS

The objects, features and advantages of the present invention will be more apparent from the following detailed description in conjunction with the accompanying drawings, in which:

FIG. 1 is a view illustrating a configuration of a diagnostic apparatus according to a first exemplary embodiment of the present invention;

FIG. 2 is a flowchart illustrating a diagnostic method in accordance with the diagnostic apparatus of FIG. 1;

FIG. 3 is a view illustrating a configuration of a diagnostic apparatus according to a second exemplary embodiment of the present invention; and

FIG. 4 is a flowchart illustrating a diagnostic method in accordance with the diagnostic apparatus of FIG. 3.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

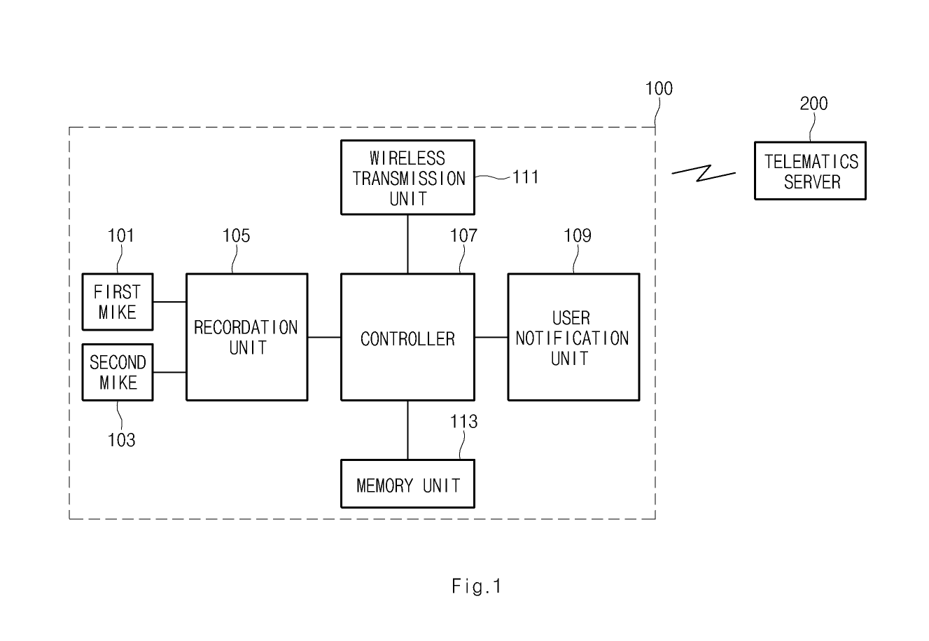

FIG. 1 is a view illustrating a configuration of a diagnostic apparatus according to a first exemplary embodiment of the present invention.

According to the illustrative embodiment shown in FIG. 1, a diagnostic apparatus 100 includes a first microphone 101, a second microphone 103, a recordation unit 105, a controller 107, a user notification unit 109, a wireless transmission unit 111, and a memory unit 113. The diagnostic apparatus 100 in the illustrative embodiment is configured to communicate with a telematics server 200 through the wireless transmission unit 111.

The first microphone 101 is positioned within an engine compartment so that when a noise is detected within the engine compartment, the noise is inputted through the first microphone 101. The second microphone 103 is positioned within a vehicle's interior so that when a noise detected within the vehicle's interior; the noise is inputted through the second microphone 103. Here, the noise refers to an abnormal sound that occurs when the vehicle is being driven or stopped, and may be a product of a failure within the vehicle. In order to insure the proper recording of the noise, two or more microphones can be used to receive the noise.

Noise inputted through the first microphone 101 or the second microphone 103 in the illustrative embodiment of the present invention is recorded by the recordation unit 105. Namely, the recordation unit 105 can record the noise according to a request from the user who detects the noise. Alternatively, the recordation unit 105 can automatically record the noise if the noise inputted through the first microphone 101 or the second microphone 103 has a volume equal to or higher than a predetermined level. The predetermined level can be set as, for example, as 60, 65 or 70 decibels, and can vary depending on a driving speed of the vehicle. Also, the predetermined level can be set by the user.

The noise recorded by the recordation unit 105 is then analyzed by the controller 107 to determine whether a vehicle break down has occurred. The controller 107 analyzes the recorded noise by using, e.g., a Fast Fourier Transform (FFT) and can detect the location of a failed part according to an analyzed noise pattern.

For example, when a rattling metal marble sound is recorded upon starting an engine, a fault in a bearing can be detected. As a further example, when a screeching sound is recorded when applying a break, a worn-out break lining or break pad can be detected and when a sound from a wheel when the vehicle is traveling is recorded and a sound intensity is proportional to the driving speed, it can be detected that a foreign material such as a nail or stone exists on a tire. As even yet a further example, when a creaking sound generated when the vehicle hits a bump is recorded, a fault in a shock absorber can be detected.

Alternatively, for example, when an abnormal knocking sound occurs upon departure or acceleration of the vehicle is recorded, inaccurate ignition timing, poor quality of fuel or carbon contamination of a spark plug can be detected. Additionally, when a noise generated by operating an air conditioner is recorded, an excessive charge of an air conditioner gas or a defect in an air conditioner compressor can be detected; and when a noise is recorded when the vehicle is driven with a gear shift in a drive or neutral position, a fault in a clutch disk due to a transmission related problem can be detected.

The controller 107 can analyze either the noise inputted through the first microphone 101 only, or analyze the noise inputted through the second microphone 103 only, or analyze combination of noise inputted through the first microphone 101 and the second microphone 103. Thus, the controller 107 includes a channel conversion unit for converting a noise transmitted from two or more microphones into a signal and a demodulation unit for reproducing the signal through the user notification unit 109. Also, the controller 107 can control predetermined criteria used by the recordation unit 105, as well as the user notification unit 109, the wireless transmission unit 111 and the memory unit 113.

The user notification unit 109 is a module that corresponds to a voice output unit and a display unit. The user notification unit 109 can notify a user of a noise level recorded by the recordation unit 105 by using a voice or an image or notify the user/driver of the location of the failed part detected by the controller 107. Also, the user notification unit 109 can provide diagnostics information transmitted from the telematics server 200 to the user.

The recorded noise or a noise analysis result of the controller 107 is transmitted by the wireless transmission unit 111 to the telematics server 200. The telematics server 200 can then perform a more precise diagnosis by using information transmitted from the wireless transmission unit 111 and transmit a diagnosis result, which includes the location of the failed part, to the diagnostic apparatus 100 through the wireless transmission unit 111.

More specifically, the noise recorded by the recordation unit 105 is stored within the memory unit 113, and when the user wants to reproduce the recorded noise, whether in the service station or for a self check up, the recorded noise can be outputted to the user notification unit 109.

The telematics server 200 communicates with the wireless transmission unit 111 via a wireless communication network. The telematics server 200 can transmit, for example, vehicle maintenance information, vehicle breakdown information, or navigation services to the vehicle. In additions to the functions described above, the telematics server 200 can also perform a breakdown diagnosis more accurately based on the recorded noise or the noise analysis result transmitted from the wireless transmission unit 111. In order to do so, the telematics server 200 can include a diagnostics database for storing diagnostic criteria or a predetermined input and output module for allowing an experienced mechanic to conduct an analysis.

In some embodiments of the present invention, the diagnostic apparatus 100 can be embodied as an audio video navigation (AVN) device. Thus, the AVN device can also include the second microphone 103, the recordation unit 105, the controller 107, the user notification unit 109, the wireless transmission unit 111 and the memory unit 113.

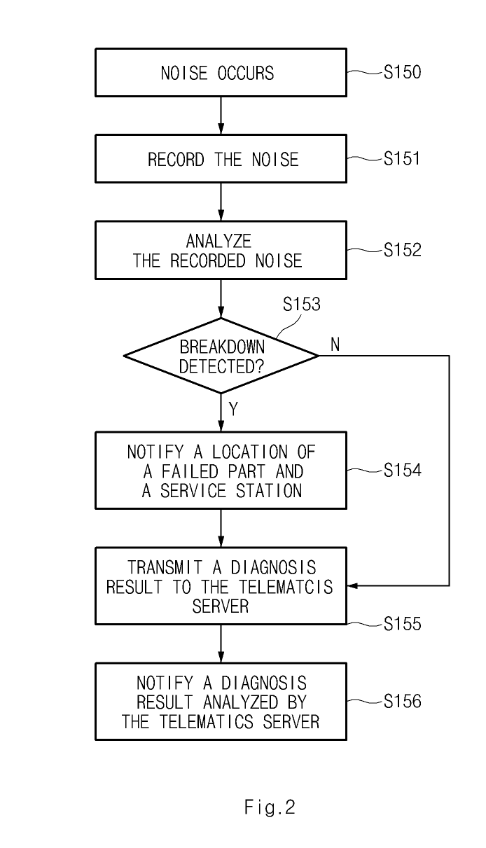

FIG. 2 is a flowchart illustrating a diagnostic method in accordance with the diagnostic apparatus of FIG. 1.

As shown in FIG. 2, when a noise occurs in a vehicle (S150), the noise is inputted through the first microphone 101 and the second microphone 103 and recorded by the recordation unit 105 (S151). The noise can be recorded either according to the request from the user who detects the noise or automatically when the inputted noise has a volume equal to or higher than a predetermined level.

Next, the recorded noise is analyzed by the controller 107 (S152). The controller 107 diagnoses the breakdown of the vehicle based on a signal waveform obtained from an analysis of the noise and identifies whether the noise is associated with a failure of a part within the vehicle, thus indicating a breakdown of the vehicle (S153).

When the breakdown is detected, the controller 107 determines the location of the failed part and notifies the user of the location of the failed part on the user notification unit 109 and/or notifies a service station. This service station can be previously selected as a default service station by a user, a service station located nearby, and/or the closest service station that is eligible to handle the repair of the failed part (S154). The location of the failed part and a location of the service station can be provided to the user via, for example, either a voice or an image. In addition, a map indicating the location of the service station or stations in which the information was sent can also be provided to the user.

Next, the controller 107 transmits the noise recorded by the wireless transmission unit 111 or the diagnosis result to the telematics server 200 (S155). The telematics server 200 then analyzes the noise by using the information transmitted from the wireless transmission unit 111 and performs the breakdown diagnosis accordingly.

Next, the diagnosis result analyzed by the telematics server 200 is transmitted through the wireless transmission unit 111 and is provided to the user through the user notification unit 109 (S156).

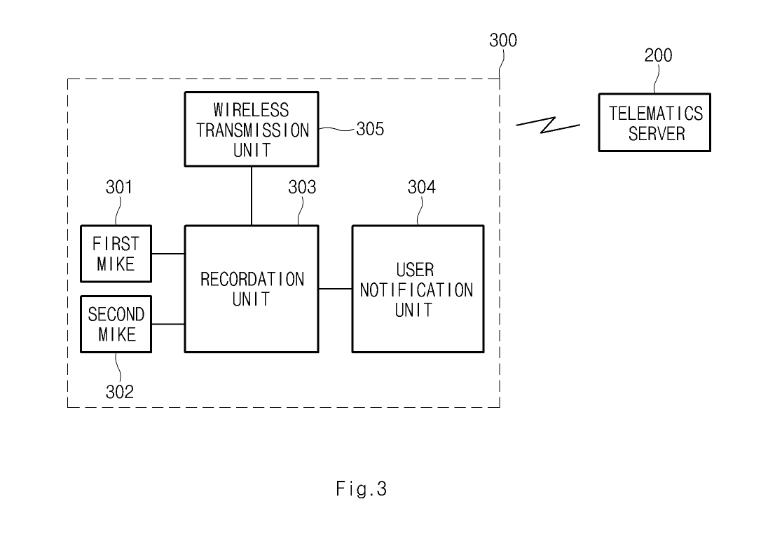

FIG. 3 is a view illustrating a configuration of a diagnostic apparatus according to a second exemplary embodiment of the present invention;

As shown in FIG. 3, a diagnostic apparatus 300 includes a first microphone 301, a second microphone 302, a recordation unit 303, a user notification unit 304, and a wireless transmission unit 305. The diagnostic apparatus 300 is configured to communicate with the telematics server 200. When the diagnostic apparatus 300 is implemented as an audio device, the second microphone 302, the recordation unit 303, and the user notification unit 304 can be embodied as the audio device. Therefore, the first microphone 301, the second microphone 302, the recordation unit 303, the user notification unit 304 and the wireless transmission unit 305 can have functions that respectively correspond to the first microphone 101, the second microphone 103, the recordation unit 105, the user notification unit 109, and the wireless transmission unit 111 of the first exemplary embodiment of the present invention that are embodied as an AVN device.

The first microphone 301 is positioned within the engine compartment to receive the noise and the second microphone 302 is positioned within the vehicle's interior to receive the noise.

As in the first embodiment described above, the recordation unit 303 records and stores the noise inputted to the first microphone 301 and the second microphone 302. The recordation unit 303 also records and stores the noise inputted to the microphones according to a user's selection or when the noise has a predetermined level or higher.

The user notification unit 304 can output the noise stored in the recordation unit 303, for example, either as a voice or an image. Therefore, when the user wants to play the recorded noise, the stored noise is played through the user notification unit 304. Also, the diagnosis result transmitted from the telematics server 200 can be outputted accordingly.

The wireless transmission unit 305 transmits the noise recorded by the recordation unit 303 to the telematics server 200 and receives an analysis result when the telematics server 200 has finished analyzing the recorded noise. The telematics server 200 then analyzes the recorded noise and performs the diagnosis of the vehicle to detect the location of the failed part.

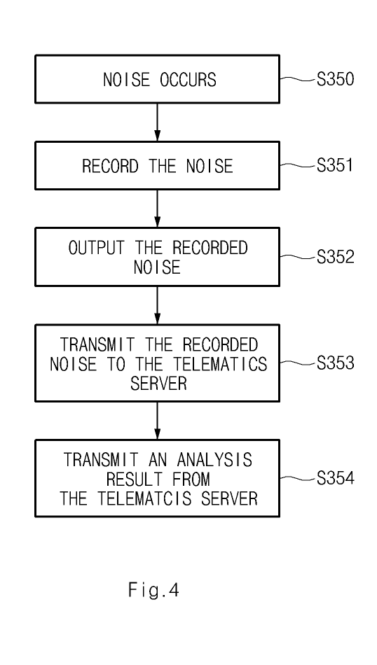

FIG. 4 is a flowchart illustrating a diagnostic method in accordance with the diagnostic apparatus of FIG. 3.

As shown in FIG. 4, when a noise that occurs in the engine compartment or the vehicle's interior, the noise is inputted to the first microphone 301 and/or the second microphone 302 (S350).

The inputted noise is recorded by the recordation unit 303 (S351) and the recorded noise is then outputted to the user notification unit 304 (S352).

The recorded noise is then transmitted to the telematics server 200 through the wireless transmission unit 305 (S353) and the diagnosis result analyzed by the telematics server 200 is transmitted through the wireless transmission unit 305 (S354). The received diagnosis result can then be outputted through the user notification unit 304.

Advantageously, the location of the failed part, which causes the noise, can be detected by the audio or navigation system mounted on the vehicle, while the breakdown can be diagnosed precisely by using the telematics server.

Therefore, a driver can locate the failed part without traveling to the service station and can record the noise that would ordinarily be difficult to reproduce, such as the noise that occurs intermittently or only when the vehicle is traveling at a high speed, thereby correctly diagnosing problems of the vehicle.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A diagnostic apparatus comprising:
a first microphone positioned within an engine compartment to receive a noise;
a second microphone positioned within an interior of a vehicle to receive the noise;
a recordation unit configured to record the noise inputted through the first microphone or the second microphone;
a controller configured to diagnose a vehicle breakdown by analyzing the noise recorded by the recordation unit; and
a user notification unit configured to, when a vehicle breakdown is detected by the controller, notify the user of a location of a failed part.

2. The diagnostic apparatus according to claim 1, wherein the user notification unit is configured to notify a service station based on the location of the failed part.

3. The diagnostic apparatus according to claim 1, wherein the recordation unit is configured to record the noise when the noise inputted through the first microphone or the second microphone has a predetermined level or higher.

4. The diagnostic apparatus according to claim 1, wherein the recordation unit is configured to record the noise according to a user choice.

5. The diagnostic apparatus according to claim 1, further comprising:
a wireless transmission unit configured to transmit the noise recorded by the recordation unit to a telematics server.

6. The diagnostic apparatus according to claim 5, wherein the telematics server is configured to analyze the transmitted noise to perform a diagnosis of the vehicle.

7. The diagnostic apparatus according to claim 5, wherein the controller is configured to receive a diagnosis result analyzed by the telematics server through the wireless transmission unit to notify a user of the diagnosis result through the user notification unit.

8. The diagnostic apparatus according to claim 1, wherein the user notification unit is configured to reproduce the noise recorded by the recordation unit.

9. A diagnostic apparatus that communicates with a telematics server, the diagnostic apparatus comprising:
a first microphone positioned within an engine compartment to receive a noise;
a second microphone positioned within an interior of a vehicle to receive the noise;
a recordation unit configured to record the noise inputted through the first microphone or the second microphone; and
a wireless transmission unit configured to transmit the noise recorded by the recordation unit to the telematics server.

10. The diagnostic apparatus according to claim 9, wherein the recordation unit is configured to record the noise when the noise inputted through the first microphone or the second microphone has a predetermined level or higher.

11. The diagnostic apparatus according to claim 9, wherein the recordation unit records the noise according to a user choice.

12. The diagnostic apparatus according to claim 9, wherein the telematics server is configured to analyze the transmitted noise to perform a diagnosis of the vehicle.

13. The diagnostic apparatus according to claim 12, wherein a diagnosis result analyzed by the telematics server is provided to a user through the user notification unit.

14. The diagnostic apparatus according to claim 9, further comprising:
a user notification unit configured to reproduce the recorded noise.

15. A method comprising
detecting a noise within a vehicle via either a first microphone positioned within an engine compartment to receive a noise or a second microphone positioned within an interior of a vehicle to receive the noise or both;
recording, by a first unit, the noise inputted through the first microphone or the second microphone or both;
analyzing, by a controller, the noise recorded by the first unit to detect and diagnose a failure in the vehicle; and
notifying, by a second unit, the user of a location of a failed part in response to the failure in the vehicle.
